(19) United States
(12) Patent Application Publication
(10) Pub. No.: US 2017/0075108 A1
(43) Pub. Date: Mar. 16, 2017

(54) LIGHT CONTROL APPARATUS

(71) Applicant: OLYMPUS CORPORATION, Tokyo (JP)

(72) Inventor: Tomohiro KITANAKA, Tokyo (JP)

(73) Assignee: OLYMPUS CORPORATION, Tokyo (JP)

(21) Appl. No.: 15/358,767

(22) Filed: Nov. 22, 2016

Related U.S. Application Data
(63) Continuation of application No. PCT/JP2015/062920, filed on Apr. 30, 2015.

(30) Foreign Application Priority Data
May 23, 2014 (JP) 2014-107499

(51) Int. Cl. G02B 27/00; H02N 2/10; G02B 5/00

(52) U.S. Cl. CPC G02B 27/0006; G02B 5/005; H02N 2/10

(57) ABSTRACT

The invention provides a light control apparatus that can easily remove foreign matters adhering thereto. The light control apparatus includes at least one substrate having an aperture (optical aperture), at least one magnet (rotary shaft member) mounted on the substrate in a rotatable manner, at least one drive blade (a light control part) attached to the magnet, and a coil, which cooperates with the magnet to constitute a driving unit that drives the drive blade. The coil and the magnet causes the magnet to rotate thereby causing the drive blade to swing between a first position and a second position so as to control incident light passing through the aperture. The light control apparatus has a vibration generating unit including the magnet, the coil, and a drive current source, which gives mechanical vibration to the drive blade through a specific path.

### CROSS-REFERENCE TO RELATED APPLICATION

The present application is a continuation application of PCT/JP2015/062920 filed on Apr. 30, 2015, which is based upon and claims the benefit of priority from Japanese Patent Application No. 2014-107499 filed on May 23, 2014; the entire contents of which are incorporated herein by reference.

### BACKGROUND OF THE INVENTION

Field of the Invention

The present invention relates to a light control apparatus.

Description of the Related Art

Japanese Patent Application H10-20360 discloses a coil element provided on a printed circuit board and a light quantity control apparatus using the same. This apparatus has stop blades that are fixed to a dipolar rotor by a shaft. The rotor is arranged to pass through a rotary hole of the coil component having a ring-shaped coil and received in shaft receptacles on upper and lower covers in a rotatable manner.

### SUMMARY OF THE INVENTION

A light control apparatus according to the present invention comprises:
at least one substrate having an optical aperture;
at least one rotary shaft member mounted on the substrate in a rotatable manner;
at least one light control part attached to the rotary shaft member;
a drive unit that drives the light control part, the drive unit causing the rotary shaft member to rotate, thereby causing the light control part to rotate between a first position and a second position so as to control incident light passing through the optical aperture; and
a vibration generating unit that gives mechanical vibration to the light control unit through a specific path.

### BRIEF DESCRIPTION OF THE DRAWINGS

FIG. 1 is an exploded perspective view of a light control apparatus according to a first embodiment;

FIGS. 2A, 2B, 2C, 2D, 2E, and 2F are diagrams illustrating relation between the electrical current supplied to a coil and the motion of a blade;

FIG. 3A is a diagram illustrating an offset in the light control apparatus, FIG. 3B is a diagram showing relation between the electrical current supplied to the coil and the offset in the light control apparatus, and FIGS. 3C, 3D, 3E, and 3F are diagrams showing the positions of the drive blade at time t0, t1, t2, and t3 respectively in a cross section;

FIGS. 4A, 4B, and 4C are diagrams illustrating how the blade moves in the swing direction and the axial direction;

FIG. 5A shows a waveform of electrical current supplied, FIG. 5B illustrates vibration of the blade in the axial direction, FIG. 5C shows another waveform of electrical current supplied, and FIG. 5D illustrates vibration of the blade in the swing direction;

FIG. 6A is a diagram showing an exemplary system configuration in which the light control apparatus 100 according to the first embodiment is further provided with a drive current source 101 and a drive mode switcher 102, and FIG. 6B shows a waveform of a signal used in a foreign matter removal mode in the first embodiment;

FIGS. 7A, 7B, and 7C are diagrams illustrating a light control apparatus according to a second embodiment;

FIG. 8 shows a waveform of a signal used in a foreign matter removal mode in a third embodiment;

FIGS. 9A, 9B, and 9C are diagrams illustrating a light control apparatus according to a fourth embodiment; and

FIGS. 10A and 10B are diagrams illustrating an offset.

### DETAILED DESCRIPTION OF THE INVENTION

In the following, embodiments of the light control apparatus according to the present invention will be described specifically with reference to the drawings. It should be understood that the present invention is not limited by the embodiments.

### First Embodiment

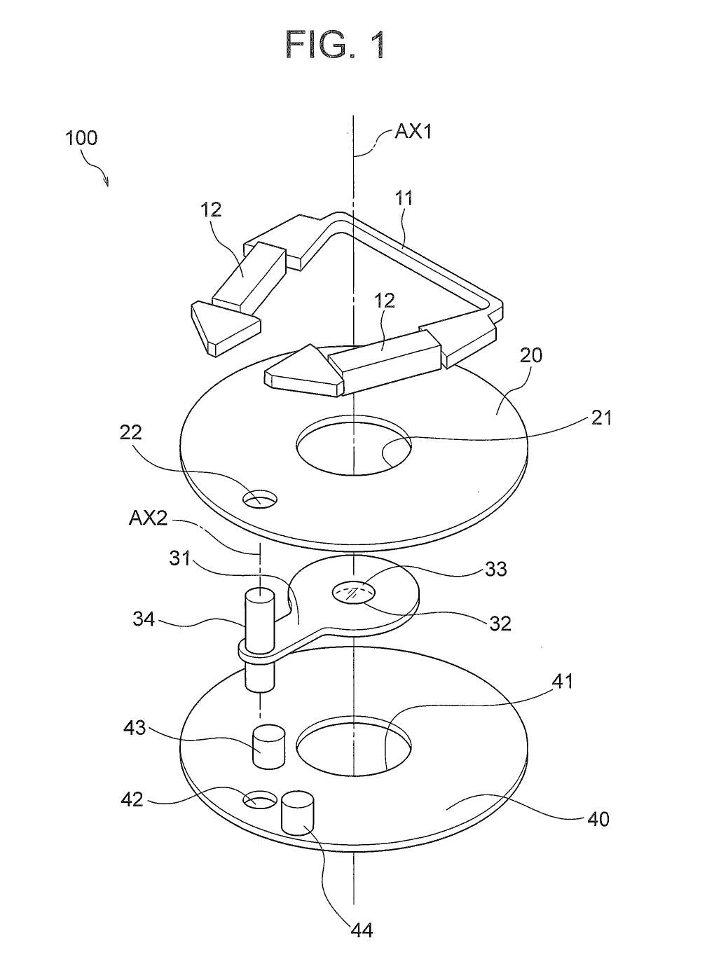

FIG. 1 is an exploded perspective view of a light control device 100 according to a first embodiment.

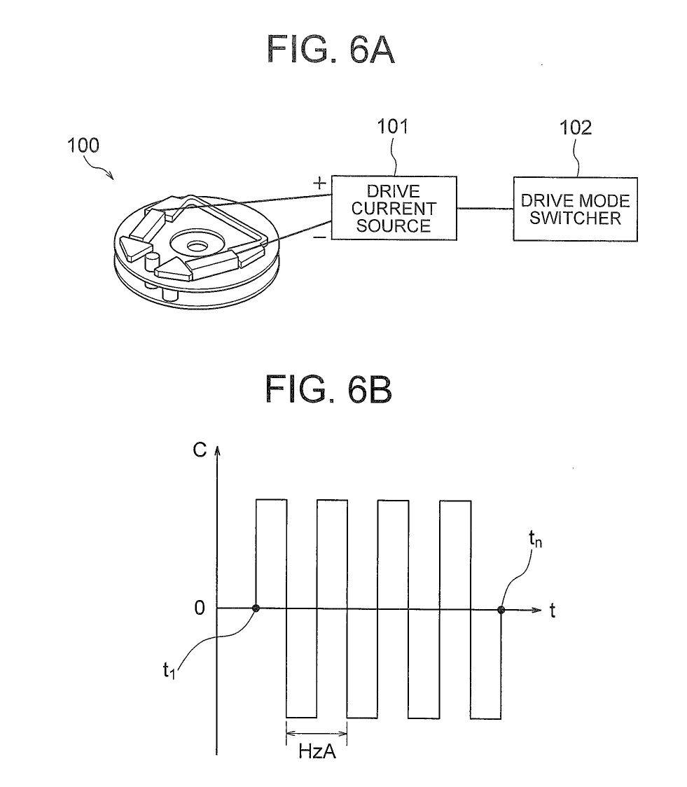

The light control apparatus 100 includes at least one first substrate 20 having an aperture (optical aperture) 21, at least one magnet 34 serving as a rotary shaft member mounted on the first substrate 20 in a rotatable manner, at least one drive blade 31 serving as a light control part attached to the rotary shaft member, and a coil 12, which cooperates with the magnet 34 to constitute a driving unit that drives the drive blade 31 as the light control unit, wherein the coil 12 and a coil core 11 cause the magnet (rotary shaft member) 34 to rotate thereby causing the drive blade (the light control part) 31 to swing between a first position (e.g. a retracted position described later) and a second position (e.g. an aperture position described later) so as to control incident light passing through the aperture 21. The light control apparatus 100 has a vibration generating unit including the magnet 34, the coil 12, and a drive current source 101 (seen FIG. 6A) that supplies an electrical current to the coil 12 to drive the magnet, which gives mechanical vibration to the drive blade (light control part) 31 through a specific path. The coil core 11 functions as a yoke also. The magnet 34 passes through holes 22, 42 on the substrates 20, 40.

The drive blade 31 has an opening 32. An optical element 33, e.g. a lens, a wavelength filter, or a density filter (ND filter) may be set in the opening 32.

In the following, how the drive blade 31 is moved in this embodiment will be described.

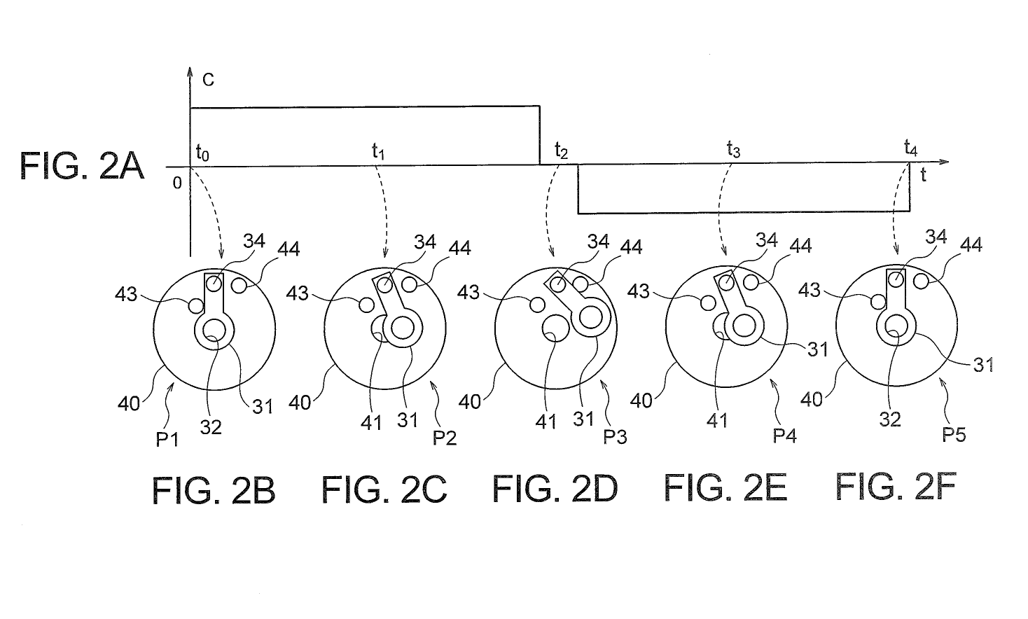

FIG. 2A shows electrical current supplied to the coil, where the horizontal axis represents the time t, and the vertical axis represents the value of the current C supplied to the coil. FIGS. 2B, 2C, 2D, 2E, and 2F show the positions of the drive blade 31 at time t0, t1, t2, t3, and t4 respectively.

At time to, supply of a constant current to the coil 12 is started. Thereby, the drive blade 31 starts to swing about the magnet 34 as the rotary shaft. At time t1, the drive blade 31 continues to swing. As the drive blade 31 swings, it abuts an abutment member 44 eventually. Then, even if the supply of current is stopped, namely even if the supplied current is made equal to zero (time t2), the drive blade stays The position P1 of the drive blade 31 shown in FIG. 2B at which the center of the opening 32 of the drive blade 31, the center of the aperture 21 of the first substrate 20, and the center of the aperture (optical aperture) 41 of the second substrate 41 are aligned will referred to as the “aperture position”.

The position of the drive blade shown in FIG. 2D at which the drive blade 31 is kept away from the aperture 41, in particular is farthest from the aperture 41, will be referred to as the “retracted position”.

As an electrical current is supplied to the coil 12 in the reverse direction, the drive blade 31 swings in the reverse direction (at time t3, as shown in FIG. 2E).

The drive blade 31 eventually abuts another abutment member 43 (at time t4, as shown in FIG. 2F). Thus, the drive blade 31 swings to the aperture position and stops at this position. Then, even if the supply of current is stopped, namely even if the supplied current is made equal to zero (time t4), the drive blade 31 stays at the same position. Thus, the drive blade 31 swings to the aperture position and stops at this position.

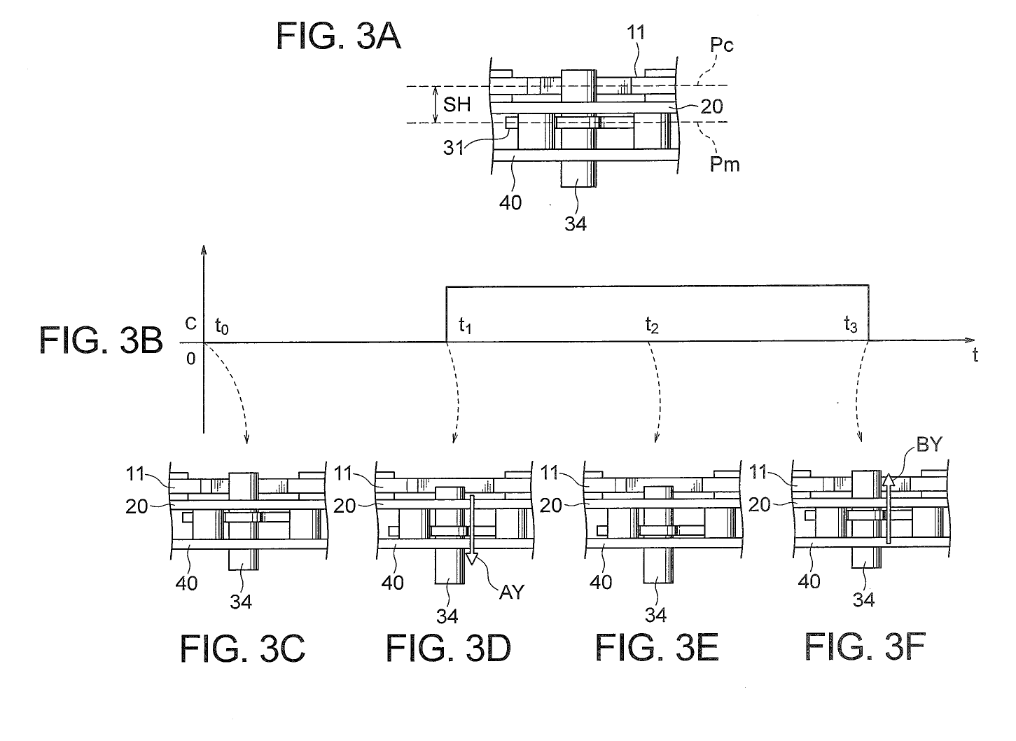

FIG. 3A is a cross sectional view illustrating an offset SH. The offset SH refers to the space between the position Pm of the center of the magnet 34 with respect to the direction of its axis AX2 and the position Pc of the center of the coil core 11 with respect to the direction of its axis AX1.

The drive blade 31 moves up and down in the offset SH while swinging. FIGS. 3C, 3D, 3E, and 3F show the positions of the drive blade 31 at time t0, t1, t2, and t3 respectively in the cross section of FIG. 3A. FIG. 3B shows the change with time of the current supplied to the coil 12.

At time t0, the supplied current is zero, and the magnet 34 is located, for example, at the retracted position. This state is shown in FIG. 3C.

At time t1, an electrical current is supplied to the coil 12. Then, the magnet 34 starts to rotate while shifting toward the lower end of the offset, namely shifting in the direction indicated by arrow AY in FIG. 3D.

In FIG. 3E, the electrical current continues to be supplied, and the drive blade 31 shifts in an offset state.

Referring to FIG. 3F, even if the supply of electrical current is stopped after swinging, the drive blade 31 stays at the aperture position. Then, the magnet 34 returns toward the upper end of the offset, namely in the direction indicated by arrow BY in FIG. 3F.

Next, how the drive blade 31 moves when electrical current is supplied to the coil 12 will be described in terms of swinging motion and axial motion separately.

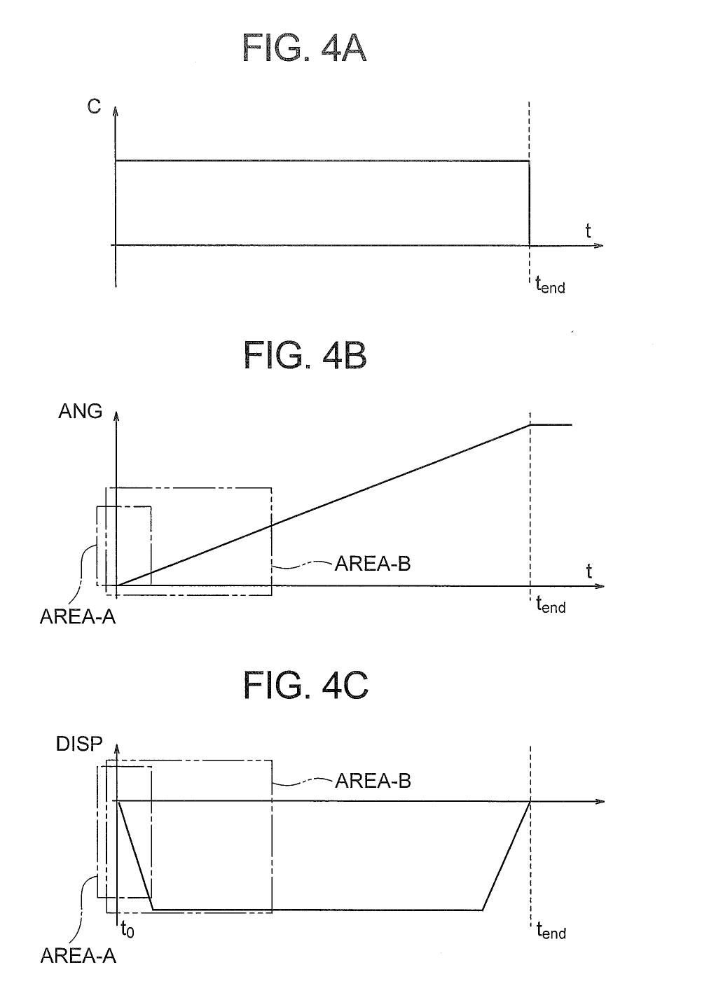

FIG. 4A shows the electrical current supplied to the coil 12, where the horizontal axis represents time t, and the vertical axis represents the current value C. FIG. 4B shows the swing angle of the drive blade 31, where the horizontal axis represents time t, and the vertical axis represents the swing angle ANG. FIG. 4C shows the axial displacement of the drive blade 31, where the horizontal axis represents the time t, and the vertical axis represents the axial displacement DISP.

Electrical current is supplied to the coil 12. In FIGS. 4B and 4C, in the area AREA-A indicated by the chain lines, the drive blade 31 swings little and can shift or displace in the axial direction AX2 of the magnet 34 (approximately 1 millisecond in one-way operation).

In FIGS. 4B and 4C, in the area AREA-B indicated by the chain double-dashed lines, the drive blade 31 swings but not so much as to abut the opposed abutment member 44. By driving the drive blade 31 periodically at a low frequency time range (5 milliseconds in one-way operation), it is possible to provide vibration in the swing direction.

This vibration in the swing direction can remove foreign matters adhering to the drive blade 31. In this operation mode, it is not necessary that the position of the center of the coil core 11 with respect to the direction of its axis AX1 and the position of the center of the magnet 34 with respect to the direction of its axis AX2 be offset from each other.

In the vibration application mode, it is preferred that vibration be given in the axial direction of the rotary shaft member by an electromagnetic drive source. Then, the operation in the axial direction is faster than the operation in the swing direction, and therefore, dust can be removed in a short time.

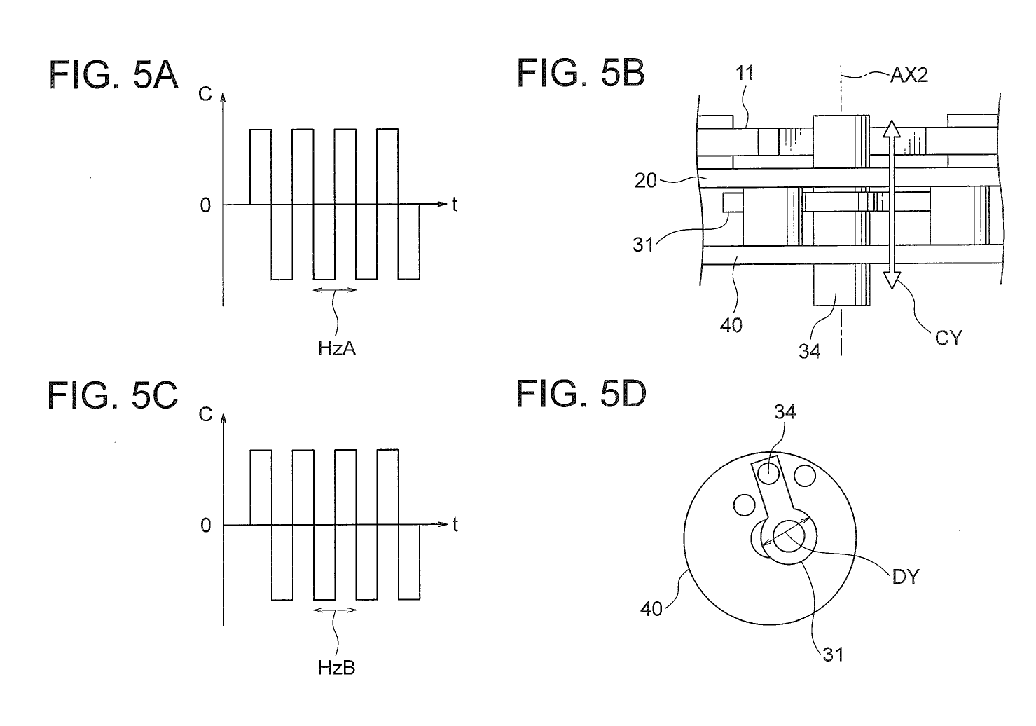

The state of the drive blade 31 in the area AREA-A indicated by the chain lines in FIGS. 4B and 4C will be specifically described. In this area, rectangular wave current having a frequency HzA of approximately 500 Hz is supplied to the coil 12 as shown in FIG. 5A.

Then, the drive blade 31 vibrates only in the direction of the axis AX2 of the magnet 34, namely in the vertical direction indicated by arrow CY, as shown in FIG. 5B. With this vibration of the drive blade 31, foreign matters can be removed.

In the area AREA-B indicated by the chain double-dashed lines, rectangular wave current having a frequency HzB of approximately 100 Hz is supplied to the coil 12 as shown in FIG. 5C. Then, as shown in FIG. 5D, vibration in the swing direction indicated by arrow DY can be given to the drive blade 31. With this vibration, foreign matters can be removed.

Now, the frequency of vibration will be described. A preferred range of the frequency fax (Hz) of axial vibration is as follows.

100 Hz≦fax≦20 kHz (1)

A more preferred range of the frequency fax (Hz) of axial vibration is as follows.

200 Hz≦fax≦2 kHz (1′)

If the vibration frequency is lower than the lower bound of the range (1), the displacement in the axial direction will be equal to or larger than 200 μm. If the vibration frequency is higher than the upper bound of the range (1), the displacement in the axial direction will be equal to or smaller than 1 μm.

If the vibration frequency is lower than the lower bound of the range (1′), the displacement in the axial direction will be equal to or larger than 100 μm. If the vibration frequency is higher than the upper bound of the range (1′), the displacement in the axial direction will be equal to or smaller than 10 μm.

A preferred range of the frequency frot (Hz) of vibration in the swing direction is as follows.

60 Hz≦frot≦4 kHz (2)

A more preferred range of the frequency frot (Hz) of vibration in the swing direction is as follows.

60 Hz≦frot≦400 Hz (2′)

If the vibration frequency is lower than the lower bound of the range (2), the drive blade 31 will overlap the opening portion by vibration when it is located at the retracted position. If the vibration frequency is higher than the upper bound of the range (2), the rotation angle will be smaller than 0.1 degree.

If the vibration frequency is lower than the lower bound of the range (2′), the drive blade 31 will overlap the opening portion by vibration when it is located at the retracted position. If the vibration frequency is higher than the upper bound of the range (2′), the rotation angle will be smaller than 1 degree.

It is preferred that the magnet 34 serving as a vibration generating unit also functions as a drive unit. This enables size reduction of the light control apparatus 100.

It is preferred that a vibration generating unit be provided separately from the magnet 34 serving as a driving unit For example, a piezoelectric element may be provided on an end of the bar-like magnet 34. It is possible to vibrate the drive blade 31 along the axial direction AX2 of the magnet 34 by causing the piezoelectric element to expand and contract periodically.

With this arrangement, vibration can be generated independently from the normal operation of the drive blade 31.

The “vibration” in the context of this specification includes the following states (1) and (2) as described above and also includes the state (3).

(1) When rectangular wave current having a frequency of approximately 500 Hz is supplied to the coil 12, the drive blade 31 moves in the axial direction AX2 of the magnet 34 at a rate higher than its swing motion. This state will be referred to as “vibration in the axial direction”. This may also be referred to as “vertical vibration”.

(2) When rectangular wave current having a frequency of approximately 100 Hz is supplied to the coil 12, the drive blade 31 moves in the swing direction of the drive blade 31 periodically. This state will be referred to as “vibration in the swing direction”. This may also be referred to as “horizontal vibration”.

(3) Sudden or abrupt motion will be referred to as “impact”. This refers, for example, a situation in which the moving drive blade 31 is stopped suddenly.

It is preferred that the “specific path” mentioned before be oriented in the axial direction AX2 of the magnet 34 as a rotary shaft member or the direction in which the magnet 34 as a rotary shaft member rotates.

Thus, vibration can be given to the drive blade 31 in two directions.

FIG. 6A shows an exemplary system configuration in which the light control apparatus 100 according to this embodiment is further provided with a drive current source 101 and a drive mode switcher 102.

In this system, a mode in which the drive blade 31 is vibrated in the axial direction AX2 of the magnet 34 is used as a mode for removing foreign matters. The drive mode switcher 102 is provided externally.

In this embodiment, it is preferred that the magnet 34 as a rotary shaft member be magnetized, the drive unit be an electromagnetic drive source including the coil 12 as a coil element and the magnet 34 (rotary shaft member), the vibration generating unit include the coil 12 and the magnet 34 (which constitute the drive unit also), and an operation mode in which the drive blade 31 is swung between the first position and the second position and a vibration application mode in which vibration is given to the light control unit be selected as desired.

Therefore, it is not necessary to modify the structure of the light control apparatus. Therefore, an increase in the size of the light control apparatus 100 can be prevented. Moreover, the addition operation can be carried out independently from the normal operation.

As described above, FIG. 6B shows the waveform of a driving signal used in the foreign matter removal mode. The frequency HzA of the driving signal is approximately 500 Hz.

The drive mode switcher 102 is not an essential component. The switching by the drive mode switcher 102 may be performed by a manual operation by a user.

### Second Embodiment

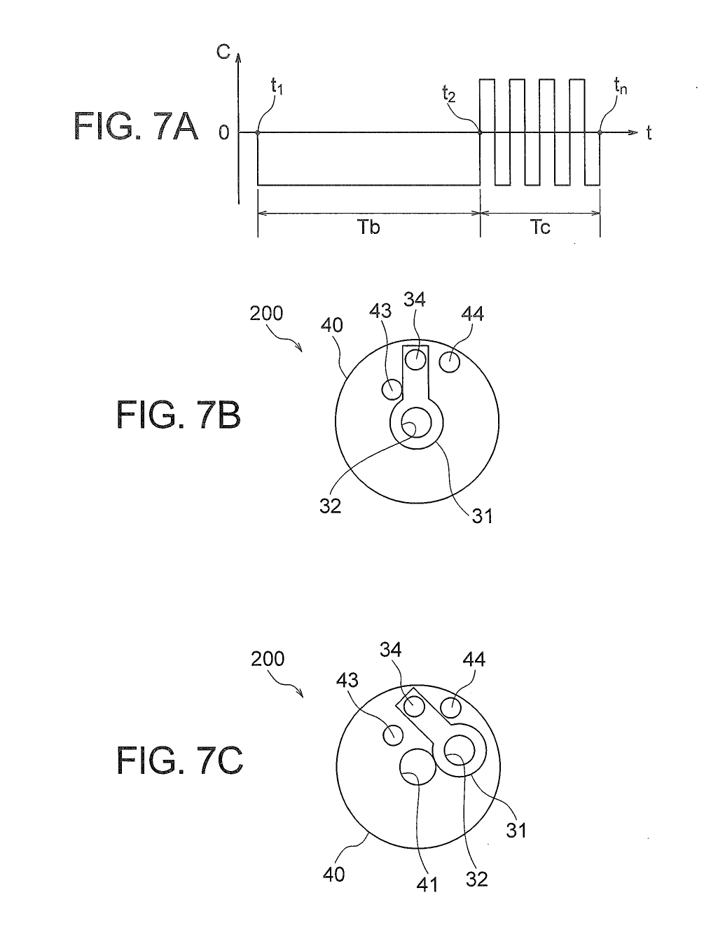

FIGS. 7A, 7B, and 7C are diagrams illustrating a light control apparatus 200 according to a second embodiment.

The mechanical structure of the light control apparatus according to the second embodiment is the same as the first embodiment. The second embodiment differs from the first embodiment in the waveform of a driving signal used in the foreign matter removal mode.

In the apparatus according to the first embodiment, if the operation for removing foreign matters is performed when the drive blade 31 is located at the aperture position (FIG. 7B), removed foreign matters may be scattered through the apertures 21 and 41 to the outside to contaminate parts around the light control apparatus.

In this embodiment, as shown in FIG. 7A, the drive blade 31 is swung from the aperture position (FIG. 7B) to the retracted position (FIG. 7C) over the period from time t1 to t2 (period Tb).

Then, during the period from time t2 to tn (period Tc) in FIG. 7A, the mode in which the drive blade 31 is vibrated in the axial direction AX2 of the magnet 34 is employed.

The vibration in the axial direction has a frequency higher than the vibration in the swing direction. Therefore, foreign matters can be removed in a short time.

### Third Embodiment

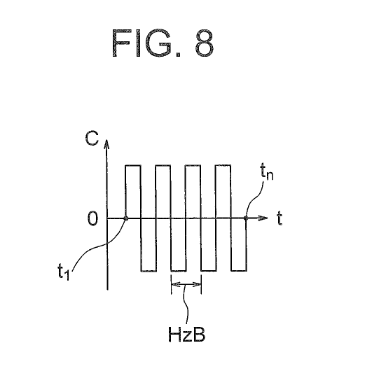

The third embodiment differs from the above-described embodiments in the waveform of a driving signal used in the foreign matter removal mode. FIG. 8 shows the waveform of a driving signal used in the foreign matter removal mode in this embodiment. The frequency HzB of the driving signal is approximately 100 Hz.

In this embodiment, a mode in which the drive blade 31 is vibrated in the direction of rotation of the magnet 34 is used. In this embodiment, the invention can be implemented without an increase in the size of the light control apparatus, and the light control apparatus can operate in the built-in state in an image pickup apparatus.

### Fourth Embodiment

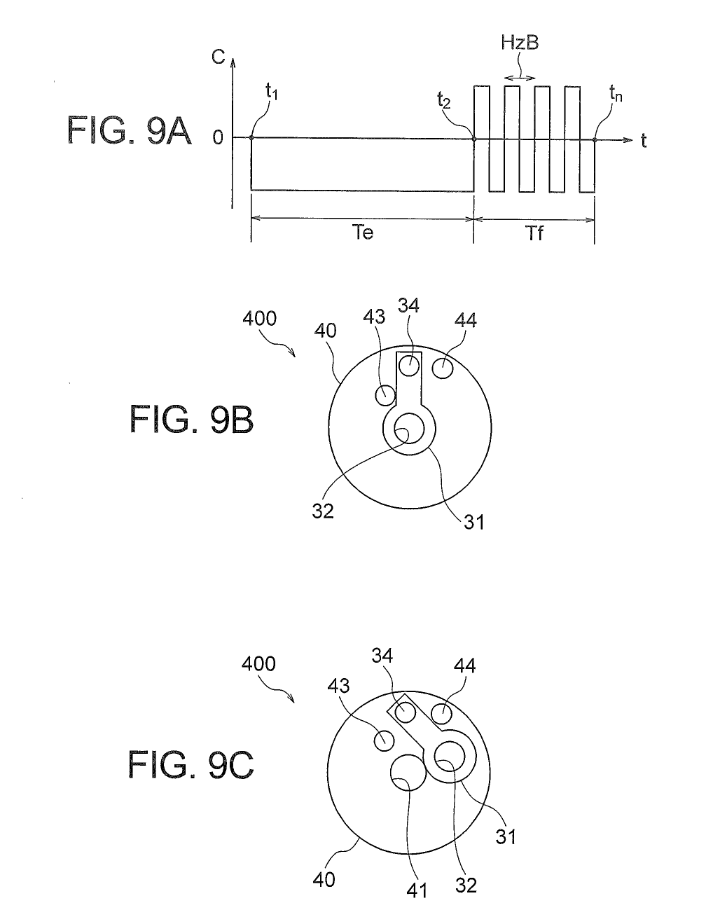

FIGS. 9A, 9B, and 9C are diagrams illustrating a light control apparatus according to a fourth embodiment. The structure of the light control apparatus according to the fourth embodiment is the same as the first embodiment. The fourth embodiment differs from the first embodiment in the waveform of a driving signal used in the foreign matter removal mode.

As described above, if the operation for removing foreign matters is performed when the drive blade 31 is located at the aperture position (FIG. 9B), removed foreign matters may be scattered through the apertures 21 and 41 to the outside to contaminate parts around the light control apparatus. A countermeasure to this problem is to vibrate the drive blade 31 after shifting the drive blade 31 to the retracted position (FIG. 9C) as in the second embodiment.

In this embodiment a mode in which the drive blade 31 is vibrated in the direction of rotation of the magnet 34 is used.

Specifically, the drive blade 31 is shifted from the position shown in FIG. 9B to the position shown in FIG. 9C during the period Te in FIG. 9A. During the period Tf in FIG. 9A, the drive blade 31 located at the retracted position is vibrated in the swing direction at a frequency HzB of approximately 100 Hz.

Thus, the present invention can be implemented without an increase in the size of the light control apparatus 400. This apparatus is advantageous in that foreign matters can be removed in the state in which the light control apparatus is built in an image pickup apparatus. Moreover, dust can be removed in short time. Furthermore, scattering of foreign matters out of the light control apparatus 400 can be prevented.

### (Modification)

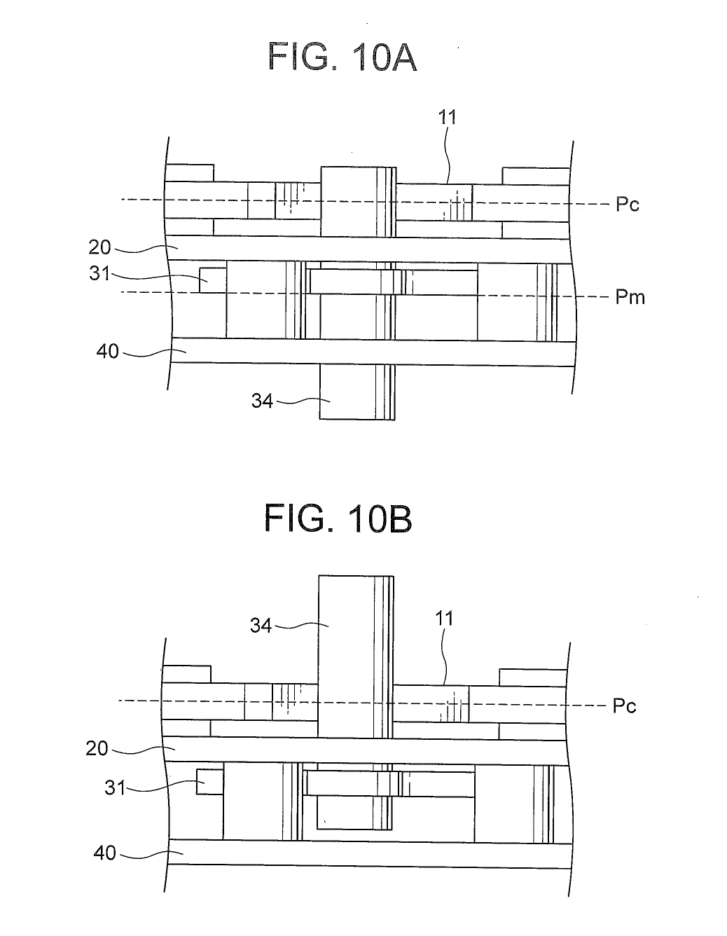

FIG. 10B is a cross sectional view of a modification of the light control apparatus. In this modification, an axial offset is provided. FIG. 10A shows a structure provided with an axial offset as descried above for comparison.

In the arrangement without an offset shown in FIG. 10B, the position Pc of the center of the coil core 11 with respect to its axial direction AX1 and the position Pm of the center of the magnet 34 with respect to its axial direction AX2 coincide with each other at position Pc (or Pm).

In this arrangement it is preferred that in the vibration application mode the electromagnetic drive source 101 cause oscillating motion in the swing direction of the drive blade 31 to give vibration in the swing direction to the drive blade 31.

This mode is advantageous in cases where it is not possible to provide an offset of the center of the magnet 34 as a rotary shaft member with respect to the direction of its axis AX2 from the center of the coil core 11 functioning as a yoke with respect to the direction of its axis AX1.

It is also preferred that in the vibration application mode, vibration of the magnet 34 as a rotary shaft member in the rotation direction be induced in the state in which the drive blade 31 is located at a position at which it is kept away from the aperture 41.

This mode is advantageous in cases where it is not possible to provide an offset of the center of the magnet 34 as a rotary shaft member with respect to the direction of its axis AX2 from the center of the coil core 11 serving as a yoke with respect to the direction of its axis AX1. This mode can prevent foreign matters from scattering out of the light control apparatus.

As described above, the light control apparatus according to the present invention is suitable for easy removal of foreign matters adhering to the apparatus.

The present invention is advantageous in providing a light control apparatus in which foreign matters adhering to the apparatus can be easily removed.

What is claimed is:

1. A light control apparatus comprising:
at least one substrate having an optical aperture;
at least one rotary shaft member mounted on the substrate in a rotatable manner;
at least one light control part attached to the rotary shaft member;
a drive unit that drives the light control part, the drive unit causing the rotary shaft member to rotate, thereby causing the light control part to swing between a first position and a second position so as to control incident light passing through the optical aperture; and
a vibration generating unit that gives mechanical vibration to the light control unit through a specific path.

2. A light control apparatus according to claim 1, wherein the specific path is oriented in the axial direction of the rotary shaft member or the direction of rotation of the rotary shaft member.

3. A light control apparatus according to claim 1, wherein the vibration generating unit functions as the drive unit also.

4. A light control apparatus according to claim 1, wherein the vibration generating unit is provided separately from the drive unit.

5. A light control unit according to claim 1, wherein the rotary shaft member is magnetized, the drive unit is an electromagnetic drive source including a coil element and the rotary shaft member, the vibration generating unit is the drive unit, and an operation mode in which the light control part is swung between the first position and the second position and a vibration application mode in which vibration is given to the light control part is selected as desired.

6. A light control unit according to claim 4, wherein the vibration generating unit is a piezoelectric element.

7. Alight control unit according to claim 5, wherein in the vibration application mode the electromagnetic drive source provides vibration in the axial direction of the rotary shaft member.

8. Alight control unit according to claim 7, wherein in the vibration application mode the electromagnetic drive source provides vibration in the axial direction of the rotary shaft member in a state in which the light control part is located at a position at which the light control part is kept away from the optical aperture.

9. Alight control unit according to claim 5, wherein in the vibration application mode the electromagnetic drive source causes oscillating motion in the swing direction of the light control part to give vibration in the swing direction to the light control part.

10. A light control unit according to claim 9, wherein in the vibration application mode, vibration in the rotation direction is given to the rotary shaft member in a state in which the light control part is located at a position at which the light control part is kept away from the optical aperture.
